(19) United States
(12) Patent Application Publication
(10) Pub. No.: US 2026/0320010 A1
(43) Pub. Date: Oct. 15, 2026

(54) INTER-TABLE DATA WRANGLING ON A DATABASE SCHEMA WITH MULTIPLE INPUT TABLES

(71) Applicant: INTERNATIONAL BUSINESS MACHINES CORPORATION, ARMONK, NY (US)

(72) Inventors: Krishnasuri Narayanam, Bangalore (IN); Ashlesha Akella, Bangalore (IN); Abhijit Manatkar, Bangalore (IN); Sameep Mehta, Bangalore (IN)

(21) Appl. No.: 19/174,864

(22) Filed: Apr. 9, 2025

(51) Int. Cl. G06F 16/215; G06F 16/21; G06F 16/22

(52) U.S. Cl. CPC G06F 16/215; G06F 16/212; G06F 16/221; G06F 16/2282

(57) ABSTRACT

Data wrangling is performed on a database schema with multiple input tables. A plurality of the input tables are filtered to drop columns that are not relevant to the data wrangling. The input tables that have been filtered and that have relevant columns are joined into a single temporary table. Data wrangling is performed on the single temporary table to produce at least one updated cell value. The at least one updated cell value is propagated back into at least one of the input tables.

### BACKGROUND

### Technical Field

The present disclosure generally relates to data processing, and more particularly, to data wrangling.

### Description of the Related Art

Cleaning of data for data quality is also known as data wrangling. Some examples of data wrangling tasks include data imputation, error detection, error correction and entity matching.

Data wrangling is typically performed on a single table.

### SUMMARY

According to various embodiments, a computer-implemented method, a computer system, and a computer program product are provided for performing data wrangling on a database schema with multiple input tables. A plurality of the input tables are filtered to drop columns that are not relevant to the data wrangling. The input tables that have been filtered and that have relevant columns are joined into a single temporary table. Data wrangling is performed on the single temporary table to produce at least one updated cell value. The at least one updated cell value is propagated back into at least one of the input tables.

In some embodiments, the filtering further includes dropping redundant rows after the dropping of columns that are not relevant.

In some embodiments, it is ensured that at least some of the filtered tables have at least one join path in order to be joined into the single temporary table.

In some embodiments, the ensuring includes selecting a join path among a plurality of join paths. The selecting includes determining semantic relevance for each of the plurality of join paths, and selecting a join path having highest semantic relevance.

In some embodiments, a target column is identified in one of the input tables (the table of interest). Intra-table data wrangling is performed on the table of interest if there is a functional dependency among columns of the table of interest that derives the target column.

In some embodiments, a set of the columns that are most relevant is identified. During the filtering, columns that are not in the set are dropped.

In some embodiments, identifying the set of columns that are most relevant incudes computing statistical measures of correlation of all of the columns for all of the input tables, and using semantics of the input tables and the statistical measures to identify the columns in the set.

In some embodiments, identifying the set of columns that are most relevant incudes creating a text corpus for all columns of each of the input tables, tokenizing each text corpus to produce a plurality of tokens, calculating a relevance score for each token in the plurality of tokens, and selecting the columns in the set from top-k highest scoring tokens.

In some embodiments, identifying the set of columns that are most relevant incudes using reinforcement learning and a Markov Decision Process (MDP) framework to compute a final state space of columns, and selecting the set of columns from the final state space.

In some embodiments, identifying the set of columns that are most relevant incudes based on a current state space of a Markov Decision Process (MDP), constructing a Large Language Model (LLM) prompt for each candidate column of a plurality of columns in the input tables, and executing the LLM prompt for each candidate column to add/remove each candidate column to/from the current state space. Once a final space state has been reached, the set of columns are selected from the final state space.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a particularly configured computing environment for performing data wrangling on a database schema with multiple tables, consistent with an illustrative embodiment.

FIG. 2 is a data wrangling method, consistent with an illustrative embodiment.

FIG. 3 is a method of selecting a join path between a table of interest and another table, consistent with an illustrative embodiment.

FIG. 4 is an example of applying a data wrangling method, consistent with an illustrative embodiment.

FIG. 5 is a method of identifying relevant columns in a database schema with multiple tables, consistent with an illustrative embodiment.

FIG. 6 is another method of identifying relevant columns in a database schema with multiple tables, consistent with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

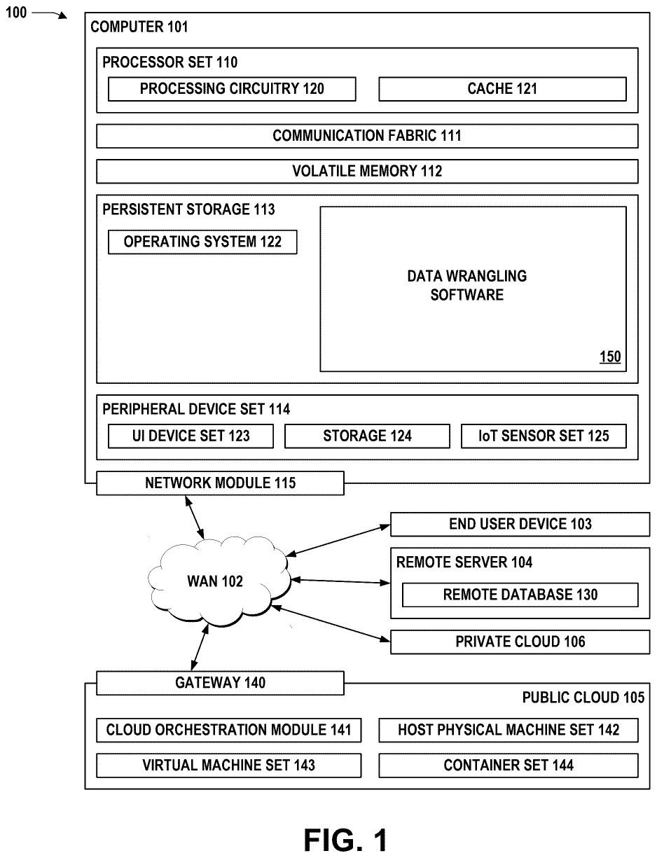

Reference is made to FIG. 1. A computing environment 100 includes an example of an environment for the execution of at least some of the computer code involved in performing the inventive methods, such as computer code in data wrangling software 150. The computing environment 100 includes, for example, computer 101. The computing environment 100 may also include other features, such as a wide area network (WAN) 102, end user device 103, remote server 104, public cloud 105, and private cloud 106. In this embodiment, the computer 101 includes processor set 110, communication fabric 111, volatile memory 112, persistent storage 113 (including operating system 122 and data wrangling software 150), peripheral device set 114 (including user interface (UI) device set 123, storage 124, Internet of Things (IoT) sensor set 125), and network module 115.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

At least some of the instructions for performing the inventive methods may be stored in persistent storage 113 as part of data wrangling software 150. The instructions, when executed, cause the processor set 110 to perform the inventive methods, including data wrangling on a database schema with multiple tables. The data wrangling software 150 may be standalone or it may be integrated with a larger operation that includes data preparation (e.g., data collection, cleaning and transformation).

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through a network. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. In some embodiments, remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example Inter-table Data Wrangling Method

As used herein, a database schema defines structure and organization of data within a database. The schema outlines how data is organized, inclusive of logical constraints, such as table names, fields, data types and the relationships between these entities. The schema serves as a blueprint for how data is stored, accessed, and manipulated.

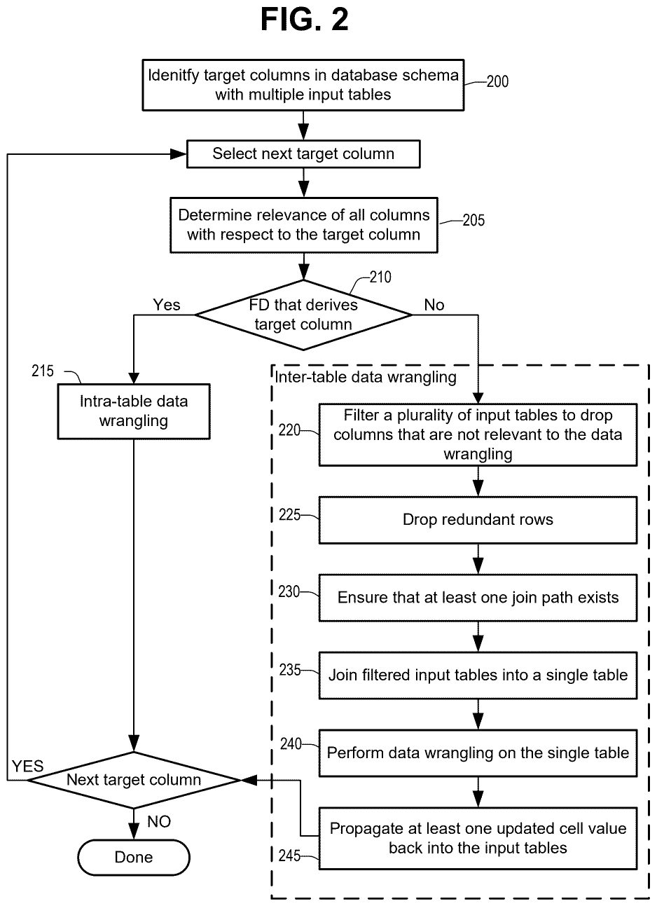

Reference is now made to FIG. 2, which illustrates a method for performing data wrangling on a database schema with multiple tables. The tables may reside on one more components of the computing environment 100 of FIG. 1. For instance, the tables may reside on one or more of the persistent storage 113, the remote server 104, the public cloud 105, and the private 106 cloud. Related metadata (e.g., data definition language statements, column/table descriptions, and information about join-columns and functional dependencies) may also reside on one or more components of the computing environment 100 of FIG. 1.

At block 200, one or more target columns in the tables are identified. As used herein, a target column refers to a column having the cell on which a data wrangling task will be applied. For example, a target column might have a cell with a missing value, and data imputation will be performed on the cell to add a value. As used herein, a table of interest refers to a table of the database schema that includes a target column.

In the example of FIG. 2, target columns are processed one at a time. The following processing is performed for each target column.

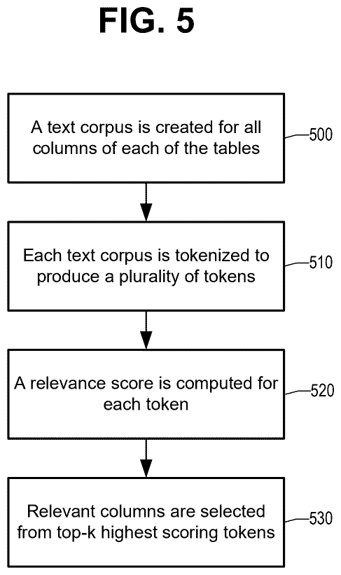

At block 205, relevance of all of the columns in all of the tables is determined with respect to the target column being processed. A first approach involves computing statistical measures of correlation of all of the columns for all of the tables. Semantics of the tables and the statistical measures are used to identify the columns that are not relevant to the target column. An example of the first approach is illustrated in FIG. 5.

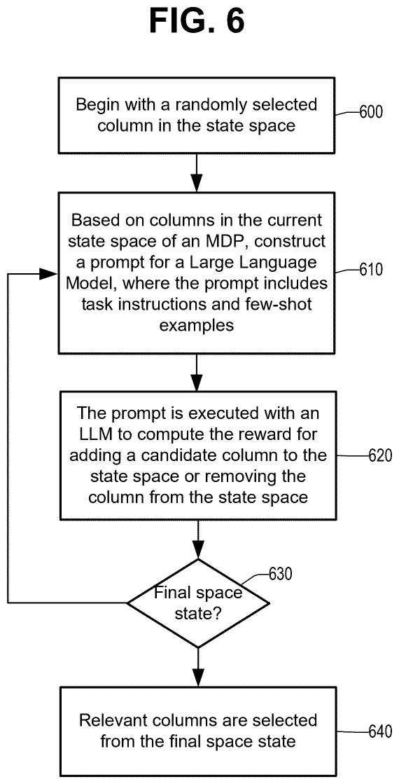

A second approach involves using reinforcement learning (RL) and a Markov Decision Process (MDP) framework to identify a state space of most relevant columns. An example of the second approach is illustrated in FIG. 6.

At blocks 210 and 215, intra-table data wrangling is performed on the table of interest if there is at least one functional dependency (FD) that derives the target column. For example, there exists at least one functional dependency that derives the target column if {X, Y, Z}->{C}, where C is the target column and {X, Y, Z} are other columns of the table of interest. As used herein, a functional dependency describes a relationship between columns in a table. For example, column A depends on column B, or column B depends on column D. In some instances, FDs may have been provided explicitly as part of the schema. In other instances, the functional dependencies are extracted. Thus, if the table of interest alone can be used with high confidence to perform the data wrangling, then the data wrangling is performed only on the table of interest.

If a functional dependency that derives the target column does not exist in the table of interest (block 210), then inter-table data wrangling is performed. At block 220, a plurality of input tables in the schema are filtered to drop columns that are not relevant to the target column. Those filtered tables having dropped columns will be reduced in size, and those filtered tables that do not include any relevant columns will be dropped. In addition, any filtered tables having only join columns will also be dropped.

When one or more columns are dropped, a filtered table might have rows that are redundant. At block 225, redundant rows are dropped. Dropping redundant rows further reduces filtered table size.

At block 230, at least some of the filtered tables are ensured to have join paths so they can be joined into a single temporary table. In some instances, a join path may be provided by a single column that exists in two or more tables.

In other instances, a join path may be provided by multiple columns. For example, a first table is joined with a table of interest via an intermediate table. The first table has a first join column with the intermediate table, and the intermediate table has a second join column with the table of interest. Hence, the first and second join columns form a join path from the first table to the table of interest.

In some instances, there will be more than one join path between the table of interest and another table. The semantic relevance of any join-path is the aggregate of the semantic relevance of the constituent columns.

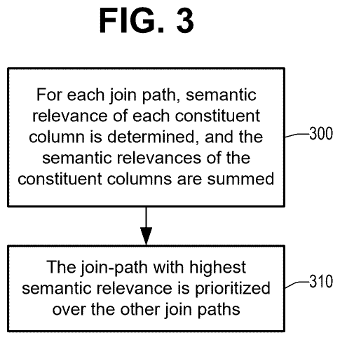

Additional reference is made to FIG. 3, which illustrates a method of selecting a join path among multiple join paths. At block 300, for each join path, semantic relevance of each constituent column is determined, and the semantic relevances of the constituent columns are summed. At block 310, the join-path with highest semantic relevance is prioritized over the other join paths.

If the join columns in the join paths are a subset of the set of relevant columns, then the tables with the relevant columns can be joined into a single temporary table. If not, further processing is performed. The set of relevant columns may be modified to include the constituent columns of one or more join paths, or the constituent columns (if dropped during the filtering) can be added back to the filtered tables.

Reference is once again made to FIG. 2. At block 235, those filtered tables that have relevant columns and join-columns are joined into a single temporary table.

At block 240, data wrangling is performed on the single temporary table to produce at least one updated cell value. Examples of data wrangling tasks include, but are not limited to, data imputation, error detection, error correction and entity matching.

At block 245, at least one updated cell value is propagated back into the target column of the table of interest and any additional tables. If an input table was discarded during filtering, then there is nothing to propagate to the discarded table. If the target column is not part of an input table, then there is nothing to propagate to that input table.

The example method of FIG. 2 illustrates the target columns being processed one at a time. In some embodiments, however, multiple target columns may be processed simultaneously.

### Example Database Schema and Application of the Example Method

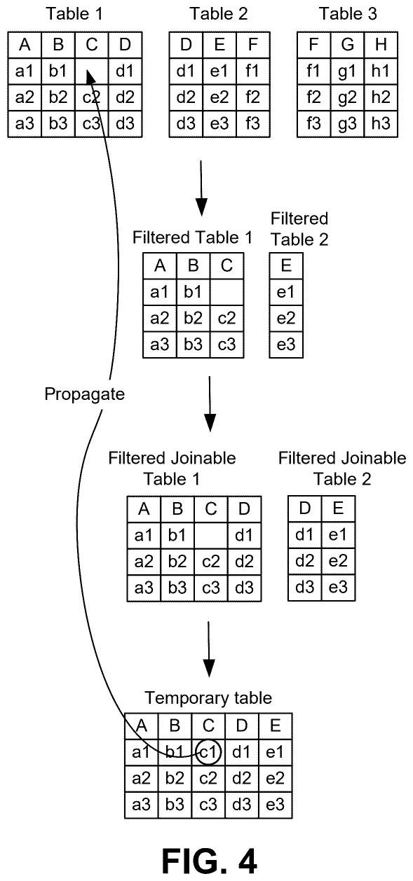

Reference is made to FIG. 4, which illustrates an example schema. Let Table 1={A, B, C, D}, Table 2={D, E, F}, and Table 3={F, G, H}. Cell c1 is missing a value. Data imputation will be performed to determine the missing value. Column C is the target column. The set of join-columns is {D, F}.

Relevance of columns A, B, D, E, F, G and H are determined with respect to the target column. Let the set of relevant columns be {A, B, E} with no functional dependencies. Inter-table data wrangling will be performed.

During filtering, column D is dropped from Table 1, column F is dropped from Table 2, and Table 3 is dropped. Filtered tables 1 and 2 cannot be joined without a join-column, so the set of relevant columns is updated to {A, B, D, E} to ensure that filtered Tables 1 and 2 can be joined.

Filtered Joinable Table 1 is joined with Filtered Joinable Table 2 to produce a single temporary table={A, B, C, D, E}. Data imputation is performed on the temporary table to fill in the value for cell c1. The updated value of cell c1 is propagated back to Table 1.

Had data imputation been performed on cell c1 with only the columns {A, B, D} of Table 1, an incorrect value for cell c1 might have been determined. Or had Tables 1, 2 and 3 been concatenated to form a large table. processing would have been more computationally intensive.

The example of FIG. 4 is relatively trivial and is provided to help explain the method of FIG. 2. In practice, there might be hundreds of input tables and hundreds of columns per input table. Combining all of these tables and columns into a single table and performing data wrangling on such a large table would be far more computationally intensive than performing the method of FIG. 2. Time complexity is O(n\hat{ }2) where n is the total number of columns. By reducing the number of input tables (for example, to 10) and the number of columns per table (for example, to 10), the method of FIG. 2 can provide a significant reduction in computational resources and a processing time.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail herein, the operational/functional language is to be read in its proper technological context, i.e., as concrete specifications for physical implementations.

It should be appreciated that the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

### First Example Method of Identifying Relevant Columns

Reference is made to FIG. 5, which illustrates a first method for identifying relevant columns in a database schema with multiple tables. At block 500, a text corpus is created for all columns of each of the tables. The text corpus for a column may be created, for example, from the column's name, description, and keywords.

At block 510, each text corpus is tokenized to produce a plurality of tokens. Word synonyms may be treated as different tokens by a term based algorithm. Tokens corresponding to synonyms may be treated as the same token by a context-based algorithm.

At block 520, a relevance score is computed for each token. A term-based ranking algorithm, such as BM25, may be used to compute the relevance scores. In the alternative, a token ranking algorithm or a concept-based algorithm may be used to compute the relevance scores.

At block 530, the relevant columns are selected from top-k highest scoring tokens. For example, if either the column name, or description of the column, or keywords associated with a column have one or more of the top-k tokens, then that column is considered a relevant column. All of the columns across all of the input tables may be ranked in this manner.

In the alternative, certain features may be weighted higher than other features. For example, tokens being part of column name may be more important and therefore, given higher weight than tokens being part of either the description of the column or the associated keywords.

### Second Example Method of Identifying Relevant Columns

Reference is made to FIG. 6, which illustrates another method for identifying relevant columns in a database schema with multiple tables. The method of FIG. 6 incorporates a Markov Decision Process (MDP). The MDP is a model for decision making when outcomes are uncertain. In an MDP that is a 4-tuple (S, A, Pₐ, Rₐ), S represents a set of states (state space), A represents a set of actions (state actions), Pₐ represents the probability that an action α in state s at time t will lead to a state s'at time t+1, and Rₐ represents the immediate reward from transitioning from state s to state s'due to action α.

Reinforcement learning (RL) utilizes the MDP framework to model the interaction between a learning agent and its environment. In this framework, the interaction is characterized by states, actions, and rewards.

In the example of FIG. 6, the MDP provides a simulation environment for learning an RL policy. Each state is a possible sequence of columns from the tables of the database schema. The actions are either adding a new column to a current sequence or finalizing the current sequence. Rewards are computed at each step by evaluating the performance of a prompt with the current sequence of columns on a validation dataset.

The prompt includes an instruction describing a data wrangling task (data imputation) to be performed, the target column, and also a few examples. Such a prompt causes a Large Language Model (LLM) to learn a new data wrangling task (e.g., data imputation) and perform the task on the target column. This technique is known as in-context learning by LLM. Each sample row includes only the cell values of the relevant columns and the target column from a validation dataset.

The validation data set may be provided along with the tables or it may be derived from the tables. Actual cell values under the target column may be masked and predicted cell values may be generated by executing a data wrangling task. A predicted cell value may be compared against a masked cell value (that is, the actual cell value). This process helps evaluate the performance and accuracy of the data wrangling task with a given set of relevant columns. The set of relevant columns with high accuracy will be the desired set.

All of the possible column sequences are not exhaustively explored. Instead, the possible column sequences are limited by a few epochs. The column sequence with highest cumulative reward is output as the final sequence.

At block 600, the method begins with a randomly selected column in the state space. At block 610, based on the columns in the current state space of the MDP, an LLM prompt is constructed to include instructions (that is, instructions to perform a data wrangling task) and few-shot examples (RL columns and the target column). The RL columns may be selected from the validation dataset.

At block 620, the prompt is executed with an LLM to compute the reward for adding a candidate column to the state space or removing the candidate column from the state space. The reward is based on the performance of the LLM output in response to the LLM prompt. A higher performance results in a greater reward.

Blocks 610 and 620 are repeated until the state space has a predefined number of columns or until a threshold number of epochs has occurred (block 630).

At blocks 630 and 640, the final state space is reached. The set of relevant columns is selected from the final state space.

The method of FIG. 6 is far more resource-intensive than the method of FIG. 5. If the set of relevant columns is to be determined in an execution environment that is resource constrained, the method of FIG. 5 may be used instead.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for performing data wrangling on a database schema with multiple input tables, the computer-implemented method comprising:
filtering a plurality of the input tables to drop columns that are not relevant to the data wrangling;
joining the input tables that have been filtered and that have relevant columns into a single temporary table;
performing data wrangling on the single temporary table to produce at least one updated cell value; and
propagating the at least one updated cell value back into at least one of the input tables.

2. The computer-implemented method of claim 1, wherein the filtering further comprises dropping redundant rows after the dropping of columns that are not relevant.

3. The computer-implemented method of claim 1, further comprising ensuring that at least some of the filtered input tables have at least one join path in order to be joined into the single temporary table.

4. The computer-implemented method of claim 3, wherein the ensuring includes selecting a join path among a plurality of join paths; and wherein the selecting comprises:
determining semantic relevance for each of the plurality of join paths; and
selecting a join path having highest semantic relevance.

5. The computer-implemented method of claim 1, further comprising:
identifying a target column in one of the input tables (the table of interest); and
performing intra-table data wrangling on the table of interest if there is a functional dependency among columns of the table of interest that derives the target column.

6. The computer-implemented method of claim 1, further comprising:
identifying a set of the columns that are most relevant;
wherein columns that are not in the set are dropped during the filtering.

7. The computer-implemented method of claim 6, wherein identifying the set of columns that are most relevant comprises:
computing statistical measures of correlation of all of the columns for all of the input tables; and
using semantics of the input tables and the statistical measures to identify the columns in the set.

8. The computer-implemented method of claim 6, wherein identifying the set of columns that are most relevant comprises:
creating a text corpus for all columns of each of the input tables;
tokenizing each text corpus to produce a plurality of tokens;
calculating a relevance score for each token in the plurality of tokens; and
selecting the columns in the set from top-k highest scoring tokens.

9. The computer-implemented method of claim 6, wherein identifying the set of columns that are most relevant comprises:
using reinforcement learning and a Markov Decision Process (MDP) framework to compute a final state space of columns; and
selecting the set of columns from the final state space.

10. The computer-implemented method of claim 6, wherein identifying the set of columns that are most relevant comprises:
based on a current state space of a Markov Decision Process (MDP), constructing a Large Language Model (LLM) prompt for each candidate column of a plurality of columns in the input tables;
executing the LLM prompt for each candidate column to decide whether to add/remove each candidate column to/from the current state space; and
once a final space state has been reached, selecting the set of columns from the final state space.

11. A computer system, comprising a memory having computer readable instructions; and
one or more processors for executing the computer readable instructions to configure the computer system to perform a data wrangling method on a database schema with multiple input tables, the method comprising:
filtering a plurality of the input tables to drop columns that are not relevant to the data wrangling;
joining the input tables that have been filtered and that have relevant columns into a single temporary table;
performing data wrangling on the single temporary table to produce at least one updated cell value; and
propagating the at least one updated cell value back into at least one of the input tables.

12. The computer system of claim 11, wherein:
the method further comprises ensuring that at least some of the filtered input tables have at least one join path in order to be joined into the single temporary table; and
for each filtered table having multiple join paths:
determining semantic relevance for each of the multiple join paths; and
selecting a join path having highest semantic relevance.

13. The computer system of claim 11, wherein the method further comprises:
identifying a set of the columns that are most relevant;
wherein columns that are not in the set are dropped during the filtering.

14. The computer system of claim 13, wherein identifying the set of columns that are most relevant comprises:
computing statistical measures of correlation of all of the columns for all of the input tables; and
using semantics of the input tables and the statistical measures to identify the columns in the set.

15. The computer system of claim 13, wherein identifying the set of columns that are most relevant comprises:
using reinforcement learning and a Markov Decision Process (MDP) framework to compute a final state space of columns; and
selecting the set of columns from the final state space.

16. A computer program product comprising one or more computer-readable memory devices encoded with data including instructions that, when executed, causes a processor set to carry out a method for performing a data wrangling method on a database schema with multiple input tables, the method comprising:
filtering a plurality of the input tables to drop columns that are not relevant to the data wrangling;
joining the input tables that have been filtered and that have relevant columns into a single temporary table;
performing data wrangling on the single temporary table to produce at least one updated cell value; and
propagating the at least one updated cell value back into at least one of the input tables.

17. The computer program product of claim 16, wherein:
the method further comprises ensuring that at least some of the filtered input tables have at least one join path in order to be joined into the single temporary table; and
for each filtered table having multiple join paths:
determining semantic relevance for each of the multiple join paths; and
selecting a join path having highest semantic relevance.

18. The computer program product of claim 16, wherein the method further comprises:
identifying a set of the columns that are most relevant;
wherein columns that are not in the set are dropped during the filtering.

19. The computer program product of claim 18, wherein identifying the set of columns that are most relevant comprises:
computing statistical measures of correlation of all of the columns for all of the input tables; and
using semantics of the input tables and the statistical measures to identify the columns in the set.

20. The computer program product of claim 18, wherein identifying the set of columns that are most relevant comprises:
using reinforcement learning and a Markov Decision Process (MDP) framework to compute a final state space of columns; and
selecting the set of columns from the final state space.
